(19) United States
(12) Patent Application Publication
(10) Pub. No.: US 2010/0186095 A1
(43) Pub. Date: Jul. 22, 2010

(54) METHOD AND SYSTEM FOR GAP BASED ANTI-PIRACY

(75) Inventors: Kenneth D Ray, Seattle, WA (US); Lonny Dean McMichael, Fall City, WA (US); James M. Alkove, Bellevue, WA (US); Patrik Schnell, Issaquah, WA (US); Chris M. Turkstra, Woodinville, WA (US); Tommer Leyvand, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/356,224

(22) Filed: Jan. 20, 2009

(51) Int. Cl. H04L 9/32

(52) U.S. Cl. 726/27

(57) ABSTRACT

In order to achieve a more robust level of piracy protection, a gap protection scheme is utilized. This protection scheme may utilize the notion of a gap, which may comprise any entity or component that is withheld from a distribution that is required in order to run or execute a software title or is required in order to play and enjoy any other type of protected asset.

### BACKGROUND

Software piracy represents a significant economic threat to the viability of commercial software development. This is particularly evident for entertainment software such as games as end users are typically more willing to accept a pirated copy of a software title than a corporate user. Global piracy is estimated to have cost the United States entertainment gaming software industry over $3.0 billion in 2007 not including losses due to Internet piracy.

Conventional anti-piracy systems typically use methods which prevent the user from gaining direct access to an asset being protected. That asset may be, for example, a game or music or an application or a video or similar piece of digital content. Conventional anti-piracy methods, however, are deficient for a multitude of reasons. In particular, once the asset has been recovered from a protection mechanism, such as by obtaining a copy of an encryption key or a copy of the asset itself or removing the embedded protections within the asset, or other such methods, the result is that the recovered asset can be used and copied anywhere. Such systems typically have mechanisms to allow updates and patches which prevent further loss of assets; however recovery of the original asset is very difficult. Peer to peer file sharing systems are filled with copies of music, videos, games, and other assets, which hackers and pirates have removed from their original protection mechanism, and which other users can freely use and play without additional restrictions, and which they can easily spread via the Internet to a multitude of other users. Conventional methods offer little opportunity for containment of a piracy outbreak once the initial loss of an asset has occurred. That is, once the copy of the asset is freely available, conventional systems do not include a mechanism which prevents use of that asset by the community.

Thus, it is desirable to develop robust methods and systems to combat software piracy in order to augment traditional loss prevention mechanisms with additional loss containment mechanisms. These methods may have direct application to combat entertainment or game title piracy and preferably should directly correlate to particular features or hardware required to play a game title. While conventional computer systems do not include the fundamental primitives for containment of audio or video or other forms of non-interactive entertainment, these fundamentals can be adapted to protect all forms of assets.

### SUMMARY

In order to achieve a more robust level of piracy protection, a gap protection scheme is utilized. This protection scheme may utilize the notion of a gap, which may comprise any entity or component that is withheld from a distribution that is required in order to run or execute a software title or is required in order to play and enjoy any other type of protected asset.

Providing restrictions on how and where the gap can be used and how and where a user can obtain an instance of the gap provides the containment. Once the asset has been leaked a user may freely obtain a copy of that asset, but must also find a free and unprotected version of the gap in order to use the asset. In this way users of the asset must perform some action. The difficulty and robustness bar of how difficult it for a user to break their instance of the gap is flexible and can be set based on business requirements; however using this containment mechanism the anti-piracy system may now have two robustness bars to prevent piracy: one that specifies how robust the system is with regard to leak prevention, a bar which is typically measured in weeks till the asset is available in the clear, and a second bar which measures the leak containment of the asset related to the amount of effort each user must undergo in order to use the asset.

The gap may, for example, take the form of code which downloads separately and runs in a security processor, or the gap may be a hardware dependence gap (“HDG”). Both types may provide loss containment, loss prevention or a combination of both.

The HDG may comprise a missing piece of functionality, which is satisfied by hardware. A per-asset HDG may comprise a form of hardware which does specific work linked to a specific asset. The strength of the HDG may be measured by the amount of engineering which is required to use the asset without using the hardware, either by emulation of the gap hardware or by porting the dependency to other hardware. For example, specialized graphics hardware can be used as a HDG, or likewise a unique CPU. The robustness bar of an HDG may also measured by what actions a user must perform, and by inference how expensive those actions are, in order to break each instance of the HDG such that it will allow uncontrolled access of its functionality and therefore allow uncontrolled use of the asset.

### BRIEF DESCRIPTION OF THE DRAWINGS

FIG. 1 illustrates various types of anti-piracy protection that may be achieved using a gap including loss prevention, loss containment or a combination thereof.

FIG. 2A illustrates a HDG according to one embodiment.

FIG. 2B illustrates a HDG with a gate according to one embodiment.

FIG. 2C illustrates an operation of a per-asset HDG according to one embodiment.

FIG. 2D illustrates an operation of a proxy-executed gap according to one embodiment.

FIG. 3A is a flowchart depicting an exemplary licensing process according to one embodiment.

FIG. 3B is a more detailed flowchart of an exemplary licensing process according to one embodiment.

FIG. 3C is a block diagram of a HDG adapted to perform licensing according to one embodiment.

FIG. 4A depicts the operation of a host device with respect to a game server in a network environment.

FIG. 4B depicts the operation of a host device with respect to a game server in a network environment with a gate.

FIG. 5 shows an exemplary system for implementing the example embodiments including a general purpose computing device in the form of a computer.

### DETAILED DESCRIPTION

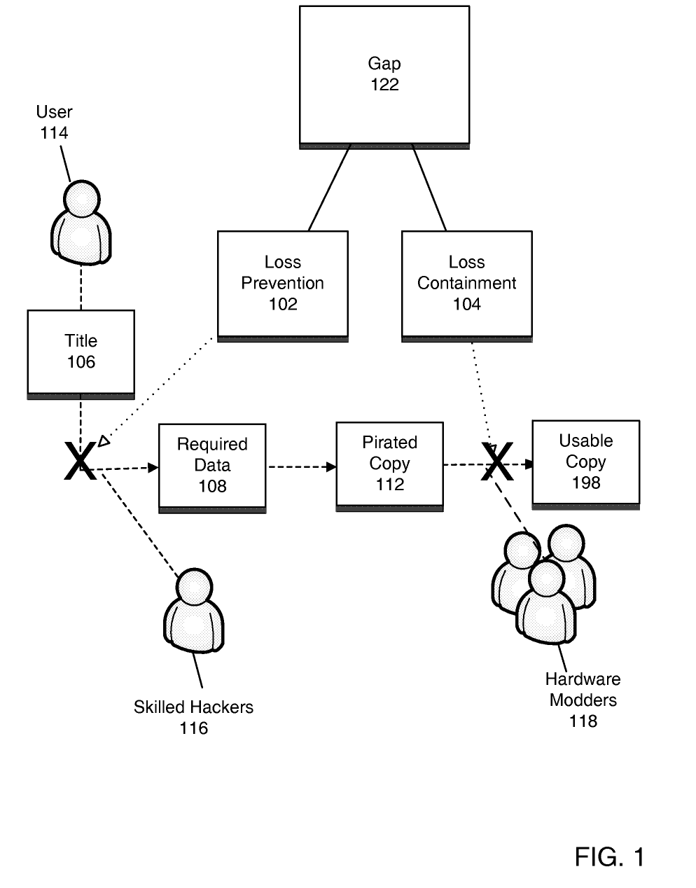

FIG. 1 illustrates various types of anti-piracy protection that may be achieved using a gap including loss prevention, loss containment or a combination thereof. Depending upon the nature and configuration, gap 122 may be utilized to realize loss prevention scheme 102 or loss containment scheme 104.

Loss prevention scheme 102, several of which are known in the art, may directly prevent data from being lost to skilled hackers 116. Using a loss prevention scheme 102, data 108 required to generate pirated copy 112 may be withheld from skilled hackers 116 for as long as possible. Secrets enabling loss prevention may be maintained in a security processor (not shown in FIG. 1), but measured boot and secure isolation techniques can enable secrets to be kept safe on the main CPU. Standard obfuscation, domain shifting, and other obscuring techniques may also be used. Most current DRM systems are classic examples of loss prevention systems, which utilize encryption, key hiding, and obfuscation, anti-debugging, etc., to prevent direct access to the protected asset.

Loss containment scheme 104, on the other hand, may be utilized to reduce the general use, usability, ease of use, and availability of a pirated copy 112 as a usable copy 198 once a loss has occurred. In particular, loss containment greatly reduces the piracy of copy 112, since it won't run on the majority of machines, either because the HDG isn't present, or because the HDG must be modified by hardware modders 118 in order to for a pirate to use the asset the outside of the original licensing restrictions. In this case hardware modders 118 are either a sub-set of users that keep track of how to modify their systems themselves in order to take advantage of security breaches or are users who are willing to pay someone else to do it for them. It is the reluctance to perform potentially damaging operations, operations that require a certain level of skill or attack hardware, or the price of skilled labor or cost of goods that greatly reduces the number of users who are able and willing to pirate, even though the asset is available in the clear with no encryption or embedded DRM protections.

The robustness bar associated with loss containment, need not be nearly as high as that for loss prevention. The purpose of loss prevention is to prevent all skilled hackers from obtaining the original asset in the clear, without encryption or any embedded DRM features. Since only one such hacker needs to succeed in order to disclose that asset to the to the community, the bar for loss prevention must both be quite high and must be constantly be adapted as breaches to the system are discovered and disclosed to other hackers. On the other hand, the purpose of loss containment is to prevent the majority of users from using the asset once it is in the clear. Here, the bar need not prevent or even discourage the hacking community, nor even the small set of the overall user base which is willing to perform the attack. Since a break to loss containment must happen on each instance of the hardware where the asset will be used, it is sufficient to set this bar high enough such that the majority of the user base will not perform the necessary operations. In addition, modification to the loss containment may only happen when breaches are discovered that makes it easy for a statistically significant number of the user base to perform the attack. Such breaches might include, for example, a software only attack that will allow the HDG to be used outside of its licensed purpose, a direct software only attack on the gate that protects the HDG, an easy translation of the asset to run on different hardware readily available to the user base such that the asset no longer has a dependency on the HDG, etc.

Gap 122 may be, for example, a proxy-executed gap or a hardware dependence gap (“HDG”) described in detail below. Each of these types may provide loss containment, loss prevention or a combination of both.

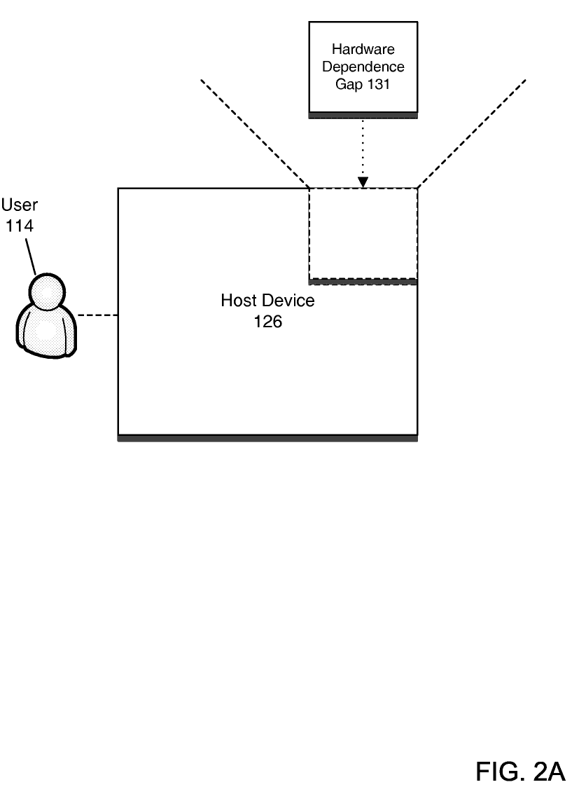

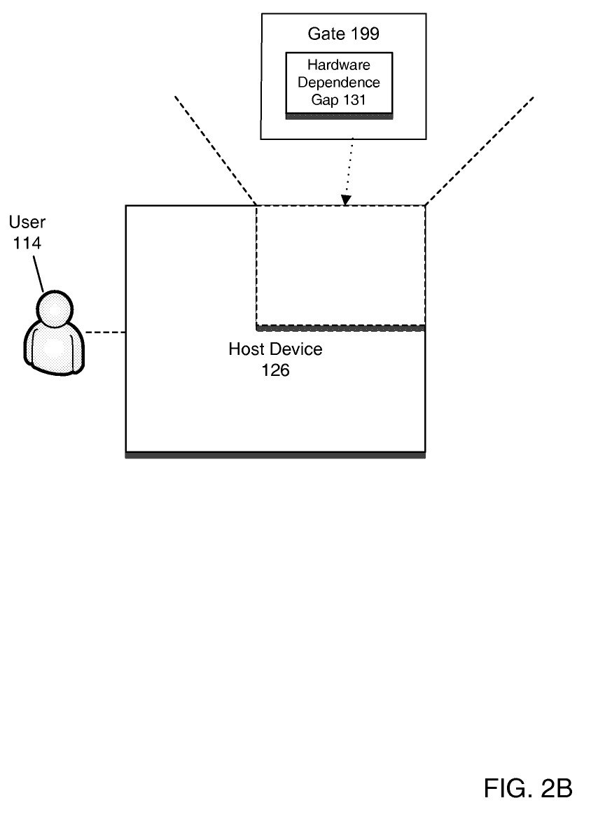

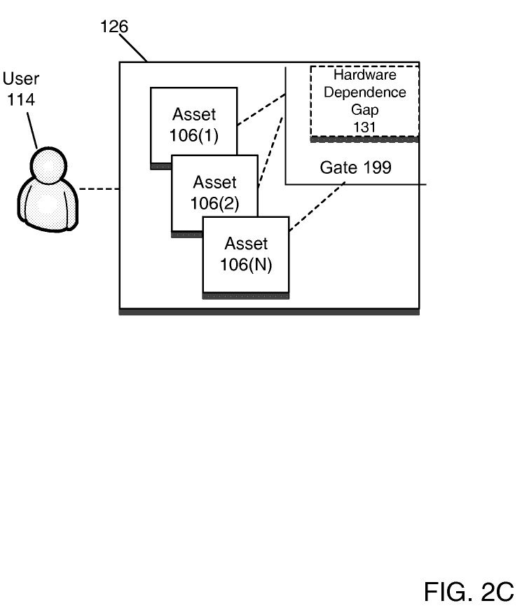

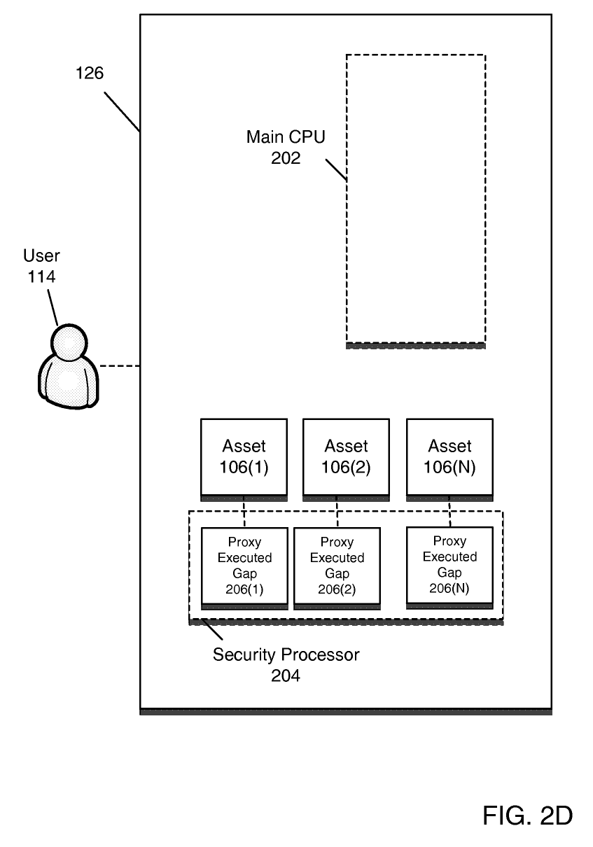

FIG. 2A illustrates a HDG according to one embodiment. According to one embodiment, HDG 131 comprises a missing piece of functionality, which is satisfied by hardware. The goal of a HDG 131 is to create an engineering dependency such that an adversary cannot create a distribution of pirated assets without either using that hardware or doing a great deal of standard engineering. Typically, HDG 131 is not readily available and would require a great deal of engineering to replace. HDG 131 may provide a loss containment scheme 104 since a user 114 of a pirated copy must either (a) obtain the hardware in question or instead (b) obtain an emulator for the hardware in question, in order to use the pirated copy. Using HDG 131, no knowledge of lost secrets can be used instead of the actual hardware. Furthermore, no modifications, nor removal of obfuscation, nor refactoring, nor domain shifting can alleviate this dependence. HDG 131 may contain piracy by restricting or stopping all sales of the hardware.

FIG. 2B illustrates a HDG 131 with a gate 199 according to one embodiment. When a gate 199 is employed, the user may already have access to the hardware, but cannot use it without breaking his instance of the gate 199. Although gate 199 is depicted in FIG. 2B (and other Figures) as surrounding the HDG 131, this is merely a logical depiction intended to represent that gate 199 is employed to assist in controlling access to HDG 131. Gate 199 need not necessarily physically surround HDG 131 and/or be separate hardware. In fact, gate 199 may, for example, be integrated into HDG 131 itself or implemented in any other suitable manner. The gate 199 may have a policy that runs within it that describes how the HDG may be used. In order for the hardware modifier, such as hardware modifier 118 of FIG. 1, to use his HDG outside of the prescribed set of uses, the user must first break in some way the gate 199. The robustness of the gate 199 can be set independently of the robustness of the loss prevention solution. The robustness of the gate 199 could be measured by what the cost or effort of the user that is required to break that gate. In the same way that there is a street price for breaking the piracy for popular console based gaming systems, as found in many web based listings offering hardware modders the service to break their consoles, the gates protecting HDGs may also have a market based price that hardware modders can pay to break their HDGs. The addition of gate 199 may allow an HDG to be made available in large quantities to large numbers of users and still maintain its containment properties. The concept of a “gate” is described in greater detail below

FIG. 2C illustrates an operation of a per-asset HDG according to one embodiment. A per-asset HDG may comprise a form of hardware which does specific work linked to a specific asset, e.g., 106(1)-106(N). In order to make it per-asset, HDG 131 may be configured such that the hardware will perform functions that are in some way tied to the specific asset, for instance the hardware is programmed with functionality that works well with one asset, but is insufficient or the wrong functionality for another asset. Most programmable hardware includes sufficient functionality that allows for this level of tying from asset to hardware programming. The gate 199 of the HDG controls this per-asset functionality. In one embodiment the gate can setup this functionality, and the gate can read programming based licenses. In other embodiments, the gate can itself be controlled by another trusted hardware or controlled by a trusted service. In this way the HDG will only function as needed if the user has specific rights to use a specific asset, and will not allow that user to use an asset for which the user does not have specific rights. In addition, the gate can contain some form of uniqueness, such as with a unique serial number, such that assets which can be used on one instance of the HDG, cannot be used on other instances of the HDG. In one embodiment the asset can be a Game Title, where the Titles for which the user has a right to play can be played on the HDG; other Titles cannot for which the user does not have the right to play cannot be played on the HDG, and Titles downloaded for one user's machine, cannot be moved to another machine, without those users breaking the gate of the second machine. In this way, the Title, which is directly tied to a specific instance of the HDG, will provides a loss containment scheme 104.

To break a per-asset HDG, a user 114 may have several alternatives. Either a user 114 must obtain hardware that does the work through some other means. Depending on how good it is, substitute hardware may not be available or protected from distribution through other standard means.

Alternatively, in one embodiment, a user 114 must break the gate of the HDG so that it ignores any restrictions placed on the use of the HDG. For instance, in the embodiment which uses downloaded licenses which the gate directly validates, a hardware modifier may break that license checking system by several methods, such as bypassing license checking altogether, modifying the public keys to which the licenses are validated, modifying the way the gate binds the license to a specific functionality of the HDG, etc. Depending on how the hardware was engineered, this type of modification most likely will require some level of skill, may require special hardware or hardware modification, most likely will result in detectable physical alteration of the device itself, and may result in some sort of physical damage to the device.

As another alternative, an adversary may attempt to distribute an emulator for the missing functionality. This may require translating from one hardware device to another or from one set of instructions to another. As hardware functionality and computing power increases over time, the ability to emulate the HDG on newer hardware will likely become easier and easier; therefore the hardware support for this type of gap, and the assets which are protected with these mechanisms, should be chosen carefully with a reasonable understanding of how long the strength of the HDG will be maintained. In other words, over time, adversaries will eventually find it easier to build a distribution that works around the HDG entirely, rather than building a distribution that breaks the gate of the HDG.

FIG. 2D illustrates an operation of a proxy-executed gap according to one embodiment. Proxy-executed code as used herein refers to code that is necessary in order to use an asset on host device 126, but which runs someplace other than the main execution environment (i.e., main CPU 202). For example, according to one embodiment, proxy-executed gap code may run inside security processor 204. As shown in FIG. 2D, a proxy executed gap code 206(1)-206(N) may be associated respectively with each of a plurality of assets 106(1)-106(N).

According to one embodiment, a proxy executed gap may provide an effective tool for implementing a loss prevention scheme 104. A proxy executed gap such as that depicted in FIG. 2D presents a challenge in that all data is marshaled from main CPU 202 to the proxy-executed environment (e.g., security processor 204) and back again. This results in the need for a simpler interface between the two environments and renders the system vulnerable to replacements, translations, and replacement attacks.

Adversaries may attempt to breach a proxy-executed gap in several ways. First, an adversary may attempt to reengineer the component. Since the interface between main CPU and the proxy-executed environment (e.g., security processor 204) tends to be simple, the functionality contained in the proxy-executed component also tends to be simple. If the interface is too simple, an adversary can determine the functionality of the interface, and build a module to perform the same functions. The adversary can then link the created module into place in the pirated copy rather than calling out the security processor 204.

In addition, an adversary can attempt to build a code book. Because the interface tends to be simple an observation of the inputs and outputs, a poorly designed proxy-executed gap can be emulated with a table of lookups instead of actually calling the code.

In addition, an adversary may attempt to utilize domain shifting. Domain shifting is a technique of obfuscation where the inputs are rotated in some way. Bits on the key can be mapped or translated, meanings of certain fields can be reordered, indexes and offsets can be modified, etc. In almost all cases domain shifting can be detected and translated, since the knowledge of the shift is typically encoded into the code running on the main CPU 202 in some observable form. An adversary need only detect that form, provide the proper translation to the main CPU code, and then the proxy-executed gap designed to be bound to a specific asset can then be used with other translated assets.

An adversary may also attempt to utilize venn diagrams. If there are overlaps in different proxy executed gaps, an adversary can determine what functionality might be needed by each asset and discover which gaps are really needed. For example, the word on the street might be “buy Game X, it has a Gap that will play any other game in the catalog.”

Finally, an adversary may resort to stealing the secret directly out of the security processor 204. Even though it may be very expensive to do so, once a single adversary has stolen the code running in the security processor 204, that same adversary can then publish it. Any gap information contained in the published information may then become public knowledge. This situation may also provide a major advantage to an adversary that desires to re-engineer the component. In either case once the gap contained in the Security Processor has been disclosed, it no longer has interesting leak containment value.

According to one embodiment, a separate proxy-executed gap may be licensed to each specific instance of a security processor 204. This will not provide direct security, but will make it difficult for an adversary, since they will either have to require a user to download the user's copy of the proxy executed gap to be used on the security processor 204 or will have to find some way to break it out of the security processor 204.

In general and as set forth above, once a HDG 131 has been established with respect to an asset, a licensing mechanism may be established such that the HDG can protect against piracy. A HDG 131 by itself will help to ensure that the asset environment cannot be run without that hardware reducing the exposure to general purpose machines; however as the business, and the assets associated with that business, become more popular, more general purpose machines will likely have hardware which includes the HDG. According to one embodiment, because an asset requires particular hardware for use, the hardware may be initially constructed to only function in a controlled manner. According to one embodiment, this may be accomplished by placing a gate on the hardware itself, which checks to see if the asset in use is licensed.

In one embodiment, licensing code to a HDG 131 may ensure that hardware will only work for a specific asset. According to one embodiment, because the gate mechanism may be used for leak containment rather than leak prevention, it may not be necessary to implement a high security bar for breaking the hardware itself. This mechanism does not need to keep secrets in order to work. Instead it may be sufficient to deter large number of users from performing this attack.

According to one embodiment, a gate may function such that the software on the HDG has a strong tie to an actual asset being accessed on the main CPU. The HDG 131 may gate access its functionality based on a per-asset license. Software for each asset may be licensed independently so that a license for one asset does not allow a different asset to play. Licenses may be bound to specific hardware instances, the current media, etc. Furthermore, the gate may be implemented such that defeating the licensing security requires some amount of physical damage to the HDG card or instead defeating media validation.

In order to establish a hardware gate for downloaded code, the downloaded code or data may be bound to or run by the hardware in question. This may be achieved by tying a licensing scheme to particular hardware characteristics such as the metadata used to configure an object manager. As another example the hardware relationship could be the resources used by a graphics processing unit (“GPU”), the shaders used by the GPU, etc.

According to one embodiment, downloaded code or data, which controls the functionality of the HDG, may be easily identified and hashed by simple hardware embedded logic. In this way the hardware can discover when to start and stop hashing and when to check that hash against a license. The code or data may be constant or easy to make constant, such that the resultant hashes are predictable. Any changes to this code or data will change the hash, and therefore conflict with the license. The licensing scheme may further ensure that there exists no alternative ways to download or program this code or data into the hardware that avoids hash of that code and subsequent license checking. Licenses may be placed on the media, or distributed from the server, and may be part of the activation of the asset. They can be bound to the specific instance of the asset (e.g., title specific) or they can be tied to a specific instance of the hardware (i.e., the license may run on one user's HDG, but cannot be transferred to another HDG). This may be implemented by, for example, binding the license to a hardware id and/or serial number, etc., on the HDG.

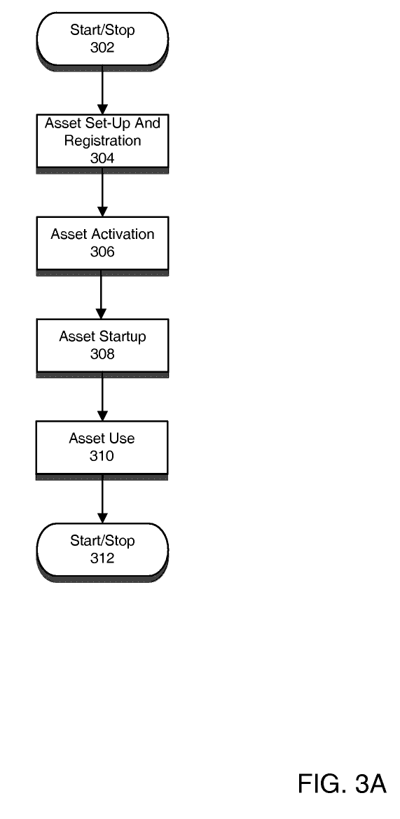

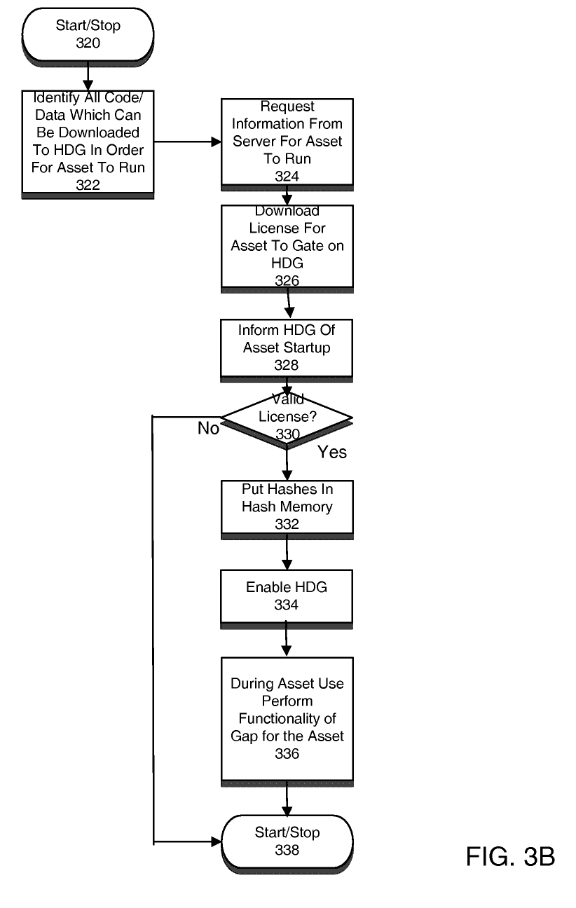

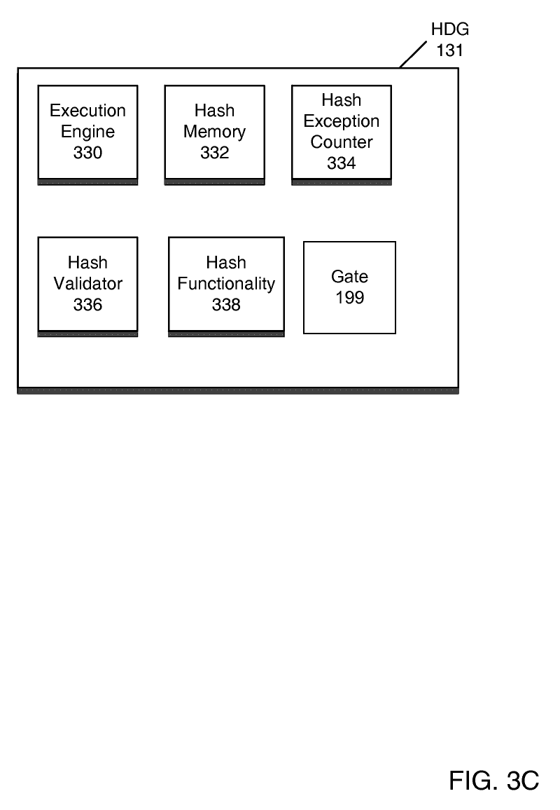

FIG. 3A is a flowchart depicting an exemplary licensing process according to one embodiment. The process is initiated in 302. In 304, asset set-up and registration is performed. In 306, asset activations are performed to activate particular assets. In 308, asset startup is performed. In 310, asset use occurs. For example, if the asset is a game, asset use may include game play. The process ends in 312.

FIG. 3B is a more detailed flowchart of an exemplary licensing process according to one embodiment. Acts 322-326 may be referred to as “activation,” while acts 328-336 may be referred to “start up.” However, it should be understood that FIG. 3B is merely an exemplary process and that any portion and/or sub-process of FIG. 3B may be performed, not performed, supplemented or altered as necessary. Alternatives may include, for example, embodiments in which activation does not require a round trip to the server. Additionally, the gate need not necessarily use a license (as described, for example, in exemplary act 326), instead, for example, it might be directly programmed, programmed by additional trusted software or hardware on the device, etc. Furthermore, as an alternative to hash, any suitable programming that binds the HDG to a specific asset may be employed for the programming of the HDG. Alternatives should still provide containment such that an adversary cannot learn a secret on the system or rework an assumption such that that adversary has sufficient tools to provide a distribution that doesn't require the end user to break their own HDG. For example, most conventional peer to peer sharing schemes generally have this flaw whereby, if an adversary breaks one system, then the adversary may be able to use that broken system to issue a peer to peer instance that will run on other HDG's.

The exemplary process shown in FIG. 3B is initiated in 320. In the embodiment where licensing of downloaded code or data is used, 322, as part of an asset set-up and registration process 304 all potential code or data, which can be downloaded to the HDG in order for an asset to run, is identified. This process will result in a list of all hashes, which need to be licensed to the HDG 131. That resulting license is then stored for each asset.

During asset activation 306 in 324 the host device may contact an asset activation service and request the information it needs in order to use that asset. The asset activation service may, for example, run as a cloud service, which the host contacts through the Internet, or as a separate system, running in a separate security context, which the host device contacts, or as special security hardware on the local system. The protocol to and from the host device and the activation service may be built using an interactive protocol, or may allow for off-line connections using various asynchronous protocols, or may include creation of all licenses cached for the host device beforehand. All such protocols and other variations of communication will work so long as it is designed with containment in mind. In other words an adversary cannot create a distribution that allows other users to use the asset without breaking their own copy of the HDG.

The information needed in order to use the asset may include, for example, the license needed for the HDG 131. At this time the asset activation service may choose to perform additional interactive checks on the host device, for instance, if optical media is used, that service may perform a media validation of the media inserted into the host device. The asset activation service may then instruct or program the gate to allow that asset to run with the HDG. For instance, in one embodiment, the service may construct a license for that asset which includes the hashes for that asset and a policy of how the asset may be used with the HDG 131. This policy can include several elements, including, for example, expiry or counter information, a mechanism which uniquely identifies a specific instance of the HDG 131, the media ID that is in the optical drive, etc. In this embodiment, once created, the asset activation service may deliver a license to the host device, which stores it for later game play.

In 326 the software on the host device may download the license for the asset that the user wants to use to the gate on the HDG 131. In 328 the software on the host device may inform the HDG of the asset startup. In 330, the gate will validate that the software on the host device is using the HDG in a valid manner. For instance, the gate may validate the license and the corresponding policy. If valid (‘yes’ branch of 330) in 332 the gate may in 334 enable and allow the programming of the HDG 131, for example, downloading code and the corresponding hashes into hash memory of the HDG. Otherwise (‘no’ branch of 330) the process ends in 338.

During asset use in 336 the HDG performs the functionality of the gap for the asset in a manner that is tied to that specific asset. In one embodiment, the HDG may properly identify the data or code by its hash thus restricting access to the HDG to only validated code. In an alternative embodiment, the gap may control access to the programming of the HDG and restrict all programming to go through the gap. In this alternative embodiment, the gate may perform some method that ensures that only valid code or data can go to the HDG. In another alternative embodiment, the HDG may turn on or off functionality within the HDG. The process ends in 338.

FIG. 3C is a block diagram of a HDG adapted to perform licensing according to one embodiment. HDG 131 may comprise execution engine 330, hash memory 332, hash exception counter 334, hash validator 336, hash hardware 338 and a gate 199.

Execution Engine 330 may perform checks to determine what data or code is downloaded prior to that data or code working on the host device. For example, execution engine 330 might be the part of the GPU that reads shaders out of the command buffer, or it could be the part of an object manager that reads metadata out of the local memory. The code or data downloaded to a particular component may be checked, by gate 199, anywhere in the process, from when it is programmed into the hardware's memory through the PCI or other bus, to just before it is used by the HDG, or as an integral part of the execution engine of the HDG 131. When HDG 131 detects invalid or unlicensed code or data it may reject that command in some way: either by ignoring those instructions, resetting itself, etc. According to one embodiment HDG 131 will only run properly with validated code.

Hash memory 332 may store hashes of downloaded code or data. The hash function used should have the property that collisions are hard to create. Current examples of such functions include SHA-256 hash or an HMAC. The hash function chosen should be consistent with the robustness level of containment desired and may take into account the cost of adding such functionality into the HDG. According to one embodiment, hash memory 332 may only be writeable by gate 199 (or by another means over which gate 199 has some direct or indirect control) and hash validator 336 and is protected from any other modifications. The amount of memory in hash memory 332 may be sufficient to store the hashes of all potential code that might be run on the HDG 131 between updates by a security processor. According to one embodiment the gate may update or allow other components to update hash memory 332 at startup time. However, according to alternative embodiments, the gate may update or allow other components to update hash memory 332 during use of the asset.

Hash functionality 338 may be a software component in the HDG or a hardware accelerated hash function, as described above, which allows HDG 131 to quickly hash code or data downloaded to it. Hash functionality 338 may rapidly identify the start and end of the code or data to be hashed. Hash functionality 338 may also identify which parts of the downloaded code or data might be required to be skipped in order to get a predictable hash measurement. According to one embodiment, the data or code being hashed may be chosen carefully such that simple hardware logic can easily determine which portions to hash.

In order to validate the code or data programmed into HDG 131, that code may be measured and compared to the known good list. Hash validator 336 may be a hardware component that checks to see if a given hash represents code valid to run on, for example a GPU. According to one embodiment, hash validator 336 first performs a hardware accelerated lookup of the given hash in hash memory 332. Hardware acceleration may include the use of a TLB to deal with frequent repeats of common shaders, as well as a multi-tiered bit look up, etc. If a hash is found, hash validator 336 may immediately return a valid result.

Hash exception counter 334 may maintain a count of exceptions with respect to hashes. If a given hash is not a current member of a hash list, then a miss threshold can be used. According to one embodiment, hash exception counter 334 counts the number of times new code is used on the HDG 131 that wasn't in the license. It is desirable to measure how many different pieces of code or data were used, not how many times a specific instance of code or data was used. In this case the hash validator 336 decrements and checks the exception counter 334. If exception counter 334 has not yet reached a threshold, then hash validator 336 may add the given hash to the hash list and return a valid result. If the hash exception counter 334 reaches the threshold, then hash validator 336 may return and invalid result and HDG 131 may take the appropriate action. In this manner the license for a specific asset can allow for a small amount of unpredicted code or data to run on the HDG.

Licenses may be placed on the media, or distributed from the server, and may be part of the activation of the asset. They can be bound to the specific instance of the asset (e.g., title specific) or they can be tied to a specific instance of the hardware (i.e., the license may run on one user's HDG, but cannot be transferred to another HDG). This may be implemented by, for example, binding the license to a hardware id and/or serial number, etc., on the HDG.

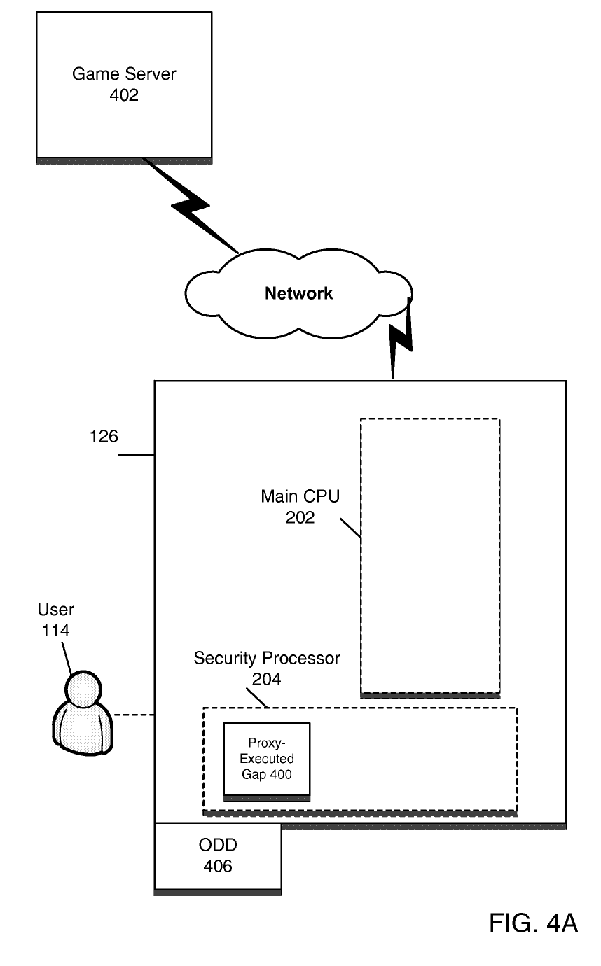

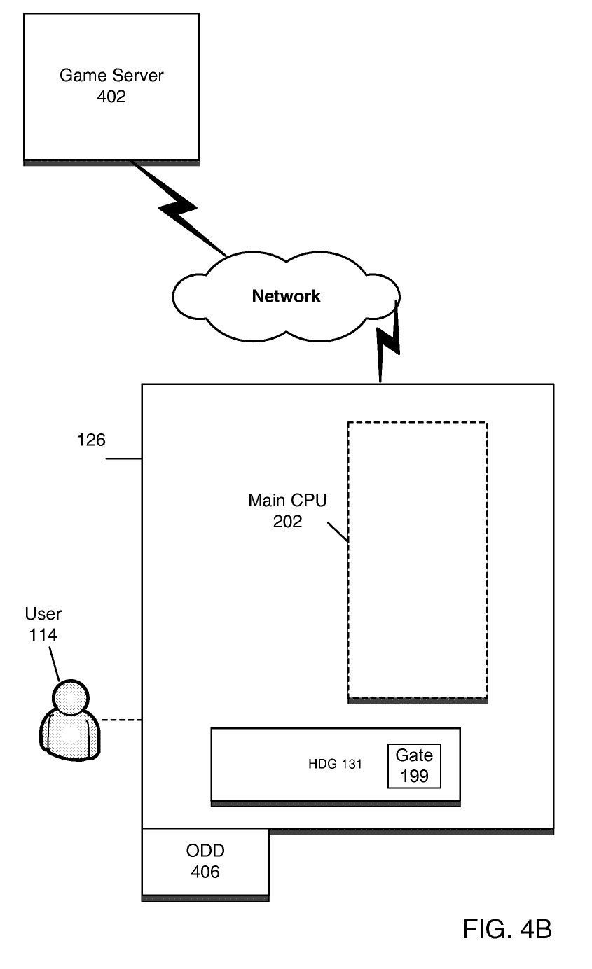

FIG. 4A depicts the operation of a host device with respect to a game server in a network environment. According to one embodiment, licensing and piracy protection may be achieved via components on host device 126 and game server 402. Game server 402 may be any type of network server that serves game licenses for download, for example, to host device 126. As will be described in more detail below, game server 402 may also participate in licensing and anti-piracy protection. Host device may comprise main CPU 202, which may utilize a security processor 204, which may execute proxy-executed gap 400. An optical disk drive (“ODD”) 406 may be coupled to host device 126 for installation of assets via an optical disk, such as a DVD. The ODD may also be used to perform media validation on the optical disk

During asset startup, the security processor 204 may validate the license for a given asset by checking the license against the unique number stored in security processor 204 as well as checking that there is valid media in the optical disk drive and that a media ID of the media in the drive matches the given license.

During asset activation, functionality within host device 126 may obtain from a asset or game server the specific license for this asset to be run and for the specific HDG 131. At game startup functionality within host device 126 may attempt to find that appropriate license associated with the asset and transmit it to security processor 204.

During asset activation game server 402 may validate that a user has a legitimate copy of the media using media validation. Game server 402 may accomplish this validation using the local security processor 204 as an intermediary to query the ODD 406. After it validates the media, game server 402 may create a license for the specific asset including the proxy-executed code for this specific asset and provide the license back to emulator 404.

The HDG functionality may be able to be turned on and off by security processor 204. According to one embodiment, as also illustrated by FIG. 4B, gate 199 may decide whether or not to turn on HDG 131 or, more granularly, turn off specific individual functionality within the HDG. Each time functionality on host device 126 desires to use HDG 131, it may send a license for the use of the hardware to gate 199, which may then validate this license, validate the policy within the license, and then turn on HDG 131 or specific functionality within HDG 131. The Policy may specify, for example, how current the last connection and validation from game server 402 should be, what the media ID in ODD 406 should be, what the specific unique number of the HDG 131 or the gate 199 is, etc. If the license is valid, gate 199 may load the hashes from the license into hash memory 332 (see FIG. 3C). Gate 199 may also obtain an exception threshold parameter from the license and set the exception counter 334 in hash validator 336 with this value (see FIG. 3C).

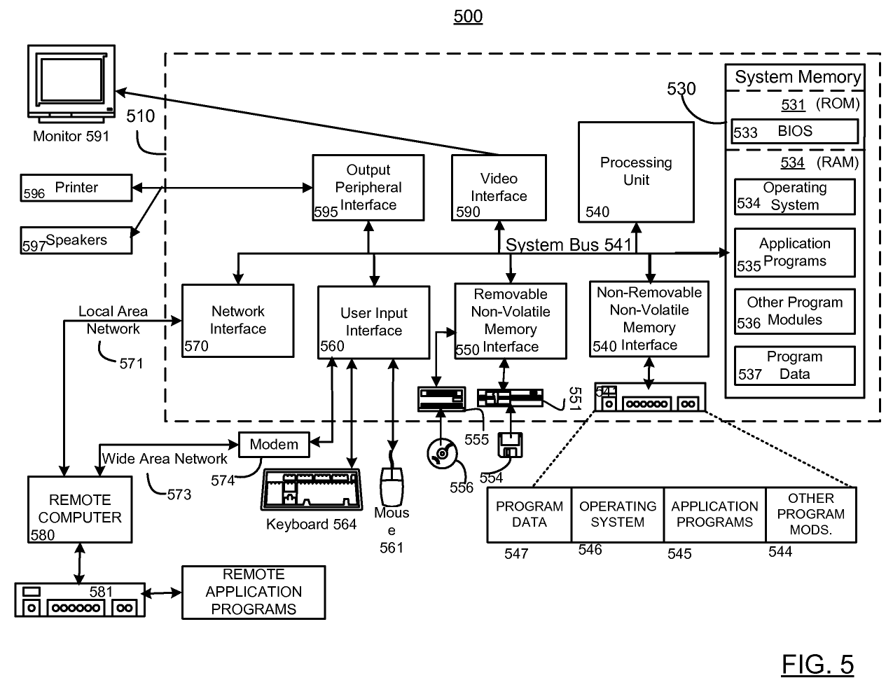

FIG. 5 shows an exemplary computing environment in which aspects of the example embodiments may be implemented. Computing system environment 500 is only one example of a suitable computing environment and is not intended to suggest any limitation as to the scope of use or functionality of the described example embodiments. Neither should computing environment 500 be interpreted as having any dependency or requirement relating to any one or combination of components illustrated in exemplary computing environment 500.

The example embodiments are operational with numerous other general purpose or special purpose computing system environments or configurations. Examples of well known computing systems, environments, and/or configurations that may be suitable for use with the example embodiments include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The example embodiments may be described in the general context of computer-executable instructions, such as program modules, being executed by a computer. Generally, program modules include routines, programs, objects, components, data structures, etc. that perform particular tasks or implement particular abstract data types. The example embodiments also may be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing the example embodiments includes a general purpose computing device in the form of a computer 510. Components of computer 510 may include, but are not limited to, a processing unit 520, a system memory 530, and a system bus 521 that couples various system components including the system memory to processing unit 520. Processing unit 520 may represent multiple logical processing units such as those supported on a multi-threaded processor. System bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). System bus 521 may also be implemented as a point-to-point connection, switching fabric, or the like, among the communicating devices.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

System memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

Computer 510 may also include other removable/non-removable, volatile/nonvolatile computer storage media. By way of example only, FIG. 6 illustrates a hard disk drive 540 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 541 is typically connected to system bus 521 through a non-removable memory interface such as interface 540, and magnetic disk drive 551 and optical disk drive 555 are typically connected to system bus 521 by a removable memory interface, such as interface 550.

The drives and their associated computer storage media discussed above and illustrated in FIG. 5, provide storage of computer readable instructions, data structures, program modules and other data for computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to processing unit 520 through a user input interface 560 that is coupled to the system bus, but may be connected by other interface and bus structures, such as a parallel port, game port or a universal serial bus (USB). A monitor 591 or other type of display device is also connected to system bus 521 via an interface, such as a video interface 590. In addition to the monitor, computers may also include other peripheral output devices such as speakers 597 and printer 596, which may be connected through an output peripheral interface 595.

Computer 510 may operate in a networked environment using logical connections to one or more remote computers, such as a remote computer 580. Remote computer 580 may be a personal computer, a server, a router, a network PC, a peer device or other common network node, and typically includes many or all of the elements described above relative to computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, computer 510 is connected to LAN 571 through a network interface or adapter 570. When used in a WAN networking environment, computer 510 typically includes a modem 572 or other means for establishing communications over WAN 573, such as the Internet. Modem 572, which may be internal or external, may be connected to system bus 521 via user input interface 560, or other appropriate mechanism. In a networked environment, program modules depicted relative to computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Computing environment 500 typically includes at least some form of computer readable media. Computer readable media can be any available media that can be accessed by computing environment 500. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing environment 500. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the subject matter has been described in language specific to the structural features and/or methodological acts, it is to be understood that the subject matter defined in the appended claims is not necessarily limited to the specific features or acts described above. Rather, the specific features or acts described above are disclosed as example forms of implementing the claims.

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

What is claimed:

1. A method for controlling piracy of an asset comprising:
generating a gap by factoring out of the asset functionality which is required to use the asset;
receiving an indication that the asset is attempting to gain access to or use the gap;
allowing access to the gap when a user is authorized to access the asset; and
restricting access to the gap when the user is not authorized to access the asset.

2. The method of claim 1, wherein the indication is received through a gate that controls access to the gap and/or functionality enabled within the gap.

3. The method of claim 2, wherein the gap comprises functionality that is tied to a specific instance of the asset.

4. The method of claim 1, wherein the asset is a software title.

5. The method of claim 4, wherein the gap comprises functionality that is title specific.

6. The method of claim 4, wherein the gap is separate software.

7. The method of claim 6, wherein the separate software is protected by a security processor and is run as proxy executed code.

8. A system for controlling piracy of an asset comprising:
a gap generated by factoring out of the asset functionality which is required to use the asset; and
a processor operative to execute instructions comprising:
receiving an indication that the asset is attempting to gain access to or use the gap;
allowing access to the gap when a user is authorized to access the asset; and
restricting access to the gap when the user is not authorized to access the asset.

9. The system of claim 8, wherein the indication is received through a gate that controls access to the gap and/or functionality enabled within the gap.

10. The system of claim 8, wherein the asset is a software title.

11. The system of claim 10, wherein the gap comprises functionality that is title specific.

12. The system of claim 10, wherein the gap is separate software.

13. The system of claim 12, wherein the separate software is protected by a security processor and is run as proxy executed code.

14. A computer readable medium having stored thereon computer executable instructions comprising:
generating a gap by factoring out of the asset functionality which is required to use the asset;
receiving an indication that the asset is attempting to gain access to or use the gap;
allowing access to the gap when a user is authorized to access the asset; and
restricting access to the gap when the user is not authorized to access the asset.

15. The computer readable medium of claim 14, wherein the indication is received through a gate that controls access to the gap and/or functionality enabled within the gap.

16. The computer readable medium of claim 15, wherein the gap comprises functionality that is tied to a specific instance of the asset.

17. The computer readable medium of claim 14, wherein the asset is a software title.

18. The computer readable medium of claim 17, wherein the gap comprises functionality that is title specific.

19. The computer readable medium of claim 17, wherein the gap is separate software.

20. The computer readable medium of claim 19, wherein the separate software is protected by a security processor and is run as proxy executed code.
